(19) United States
(12) Patent Application Publication
(10) Pub. No.: US 2007/0287720 A1
(43) Pub. Date: Dec. 13, 2007

(54) Method of Fungal Pathogen Control in Grass or Turf

(76) Inventors: Reed Nathan Royalty, Cary, NC (US); Victor Bruce Steward, Wake Forest, NC (US)

Correspondence Address: BAYER CROPSCIENCE LP, Patent Department, 2 T .W. ALEXANDER DRIVE, RESEARCH TRIANGLE PARK, NC, 27709, US

(21) Appl. No.: 11/660,803

(22) PCT Filed: Aug. 22, 2005
(86) PCT No.: PCT/US05/29907

§ 371 Date: Feb. 21, 2007

Related U.S. Application Data
(60) Provisional application No. 60/603,880, filed on Aug. 24, 2004.

(51) Int. Cl. A01N 43/40; A01N 43/54; A01P 3/00

(52) U.S. Cl. 514/269; 514/341

(57) ABSTRACT

This invention relates to a method of controlling fungal organisms in turfgrass with imidacloprid and optionally one or more other fungicides.

### BACKGROUND OF THE INVENTION

The present invention relates to the control of phytopathogenic fungal organisms on grass or turfgrasses.

It is known from WO 96/03045 (U.S. Pat. Nos. 6,114,362, 6,297,263, and 6,423,726) that an agonist or antagonist of the nicotinic acetylcholine receptor of an insect can be combined with fungicides for control of certain fungi on plants. In particular, the combinations of active compounds according to WO 96/03045 possess very good fungicidal properties and can be employed, in particular, for controlling phytopathogenic fungi, such as Plasmodiophoromycetes, Oomycetes, Chytridiomycetes, Zygomycetes, Ascomycetes, Basidiomycetes, Deuteromycetes, and the like. The active compound combinations according to according to WO 96/03045 are particularly suitable for controlling cereal diseases, such as Erysiphe, Cochliobolus, Septoria, Pyrenophora, and Leptosphaeria, and for use against fungal infestations of vegetables, grapes, and fruit, such as Venturia or Podosphaera on apples, Uncinula on vine plants, or Sphaeroteca on cucumbers.

### SUMMARY OF THE INVENTION

The present invention provides a method of controlling or suppressing a phytopathogenic infection of grass or turfgrass by a phytopathogenic fungal organism of the order Heliotales comprising applying a synergistically effective amount of a combination of (i) imidacloprid and (ii) optionally, a fungicide that is a polymeric dithiocarbamate fungicide, a strobilurin fungicide, a phenylanilide fungicide, or chlorothalonil.

### BRIEF DESCRIPTION OF THE DRAWINGS

FIGS. 1 and 2 illustrate the effectiveness of the method of the invention on various grasses.

### DETAILED DESCRIPTION OF THE INVENTION

The present invention can be practiced with all turfgrasses, including cool season turfgrasses and warm season turfgrasses.

Examples of cool season turfgrasses are bluegrasses (Poa spp.), such as kentucky bluegrass (Poa pratensis L.), rough bluegrass (Poa trivialis L.), canada bluegrass (Poa compressa L.), annual bluegrass (Poa annua L.), upland bluegrass (Poa glaucantha Gaudin), wood bluegrass (Poa nemoralis L.), and bulbous bluegrass (Poa bulbosa L.); the bentgrasses and Redtop (Agrostis spp.), such as creeping bentgrass (Agrostis palustris Huds.), colonial bentgrass (Agrostis tenuis Sibth.), velvet bentgrass (Agrostis canina L.), South German Mixed Bentgrass (Agrostis spp. including Agrostis tenius Sibth., Agrostis canina L., and Agrostis palustris Huds.), and Redtop (Agrostis alba L.); the fescues (Festucu spp.), such as red fescue (Festuca rubra L. spp. rubra) creeping fescue (Festuca rubra L.), chewings fescue (Festuca rubra commutata Gaud.), sheep fescue (Festuca ovina L.), hard fescue (Festuca longifolia Thuill.), hair fescue (Festucu capillata Lam.), tall fescue (Festuca arundinacea Schreb.), meadow fescue (Festuca elanor L.); the ryegrasses (Lolium spp.), such as annual ryegrass (Lolium multiflorum Lam.), perennial ryegrass (Lolium perenne L.), and italian ryegrass (Lolium multiflorum Lam.); and the wheatgrasses (Agropyron spp.), such as fairway wheatgrass (Agropyron cristatum (L.) Gaertn.), crested wheatgrass (Agropyron desertorum (Fisch.) Schult.), and western wheatgrass (Agropyron smithii Rydb.). Other cool season turfgrasses include beachgrass (Ammophila breviligulata Fern.), smooth bromegrass (Bromus inermis Leyss.), cattails such as Timothy (Phleum pratense L.), sand cattail (Phleum subulatum L.), orchardgrass (Dactylis glomerata L.), weeping Alkaligrass (Puccinellia distans (L.) Parl.), and crested dog's-tail (Cynosurus cristatus L.).

Examples of warm season turfgrasses include Bermudagrass (Cynodon spp. L. C. Rich), Zoysiagrass (Zoysia spp. Willd.), St. Augustinegrass (Stenotaphrum secundatum Walt Kuntze), Centipedegrass (Eremochloa ophiuroides Munro Hack.), Carpetgrass (Axonopus affinis Chase), Bahiagrass (Paspalum notatum Flugge), Kikuyugrass (Pennisetum clandestinum Hochst. ex Chiov.), Buffalograss (Buchloe dactyloids (Nutt.) Engelm.), Blue gramma (Bouteloua gracilis (H.B.K.) Lag. ex Griffiths), Seashore paspalum (Paspalum vaginatum Swartz), and Sideoats grama (Bouteloua curtipendula (Michx. Torr.).

Treatment of cool season turfgrasses are generally preferred according to the invention. More preferred is treatment of Bluegrass, Bentgrass and Redtop, Fescue, and Ryegrass. Treatment of Bentgrass is most preferred.

In particular, a combination of imidacloprid and the fungicide may be applied sequentially, separately, or together. It is preferred to apply the combination together by co-mixing the active ingredients in a tank-mix, pre-mix, or by other methods known to those of ordinary skill in the art.

In one embodiment, the combination is applied for control of Sclerotinia spp. organisms, particularly for control of Sclerotinia homoeocarpa, also known as Sclerotinia homoeocarpa, F. T. Benn.

A particularly preferred combination is imidacloprid and a polymeric dithiocarbamate fungicide. Particularly preferred polymeric dithio-carbamate fungicides are mancopper, mancozeb, maneb, metiram, polycarbamate, propineb, and zineb. A particularly preferred polymeric dithiocarbamate fungicide is mancozeb.

Generally, the weight-weight ratio of imidacloprid to the polymeric dithiocarbamate fungicide is from about 1:40 to about 1:10, preferably from about 1:30 to about 1:10 and most preferably from about 1:20 to about 1:10. In the present disclosure, unless specifically stated otherwise, the ratios of active ingredients are stated in weight-weight ratios.

The generally preferred amount of the polymeric dithiocarbamate fungicide used in the method of the present invention is from about 20 kilograms per hectare (kg/ha) to about 5 kg/ha, preferably from 12 kg/ha to about 8 kg/ha.

The generally preferred amount of imidacloprid used in the method of the present invention is from about 0.3 kg/ha to about 0.7 kg/ha, preferably from about 0.4 kg/ha to about 0.6 kg/ha. However, in some combinations with dithiocarbamate insecticides, the amount of imidacloprid used may be from 0.05 kg/ha to 0.3 kg/ha, preferably from 0.1 kg/ha to 0.25 kg/ha.

In another embodiment of the present invention the fungicide is a strobilurin fungicide. Preferred strobilurin fungicides include azoxystrobin, dimoxystrobin, fluoxastrobin, kresoxim-methyl, metominostrobin, orysastrobin, picoxystrobin, pyraclostrobin, and trifloxystrobin. Trifloxystrobin is a preferred strobilurin fungicide according to the invention.

Strobilurin fungicides are used according to the invention from about 150 to about 500 g/ha of the particular strobilurin used. Generally, the ratio of imidacloprid to a strobilurin is from 1:5 to 5:1, preferably from 1:2 to 2:1.

In another embodiment of the present invention the fungicide is a phenylanilide fungicide. Preferred phenylanilide fungicides include benalaxyl or benalaxyl-M, boscalid, furalaxyl, and metalaxyl or metalaxyl-M. Metalaxyl is a preferred phenylanilide fungicide according to the invention.

Phenylanilide fungicides are used according to the invention from about 200 to about 800 g/ha of the particular phenylanilide fungicide used. Generally, the ratio of imidacloprid to the phenylanilide is from 1:5 to 5:1, preferably from 1:3 to 3:1.

In another embodiment of the present invention the fungicide is clorothalonil. Clorothalonil is generally used in combination with imidacloprid at a rate from 3 to 20 kg/ha. Generally, the weight-weight ratio of imidacloprid to chlorothalonil is from about 1:40 to about 1:10, preferably from about 1:30 to about 1:10 and most preferably from about 1:20 to about 1:10.

In another embodiment of the invention there is provided a method of controlling or suppressing a phytopathogenic infection of grass or turfgrass by a phytopathogenic organism of the family Rhizoctonia or Pythium by applying a synergistically effective amount of a combination of (i) imidacloprid and (ii) a polymeric dithiocarbamate fungicide.

For the control of Rhizoctonia or Pythium diseases, generally, the weight-weight ratio of imidacloprid to the polymeric dithiocarbamate fungicide is from about 1:80 to about 1:10, preferably from about 1:60 to about 1:10 and most preferably from about 1:40 to about 1:10. The amount of the polymeric dithiocarbamate fungicide used in the method of the present invention is from about 20 kilograms per hectare (kg/ha) to about 5 kg/ha, preferably from 12 kg/ha to about 8 kg/ha.

The amount of imidacloprid is from about 0.3 kg/ha to about 0.7 kg/ha, preferably from about 0.4 kg/ha to about 0.6 kg/ha.

In another embodiment of the present invention there is provided a method of controlling a powdery mildew (that is, Erysiphe graminis) infection in turfgrass by applying an effective amount of a composition consisting essentially of imidacloprid to the turfgrass that is infected or expected to be infected with powdery mildew.

Such control is effected generally by using from 0.1 to 2 kg/ha of imidacloprid, preferably from 0.2 to 1 kg/ha and more preferably from 0.2 to 0.5 kg/ha.

In another embodiment of the present invention there is provided a method of controlling Curvularia spp. infections in a Poa spp. turfgrass by applying a composition consisting essentially of imidacloprid to the turfgrass. Preferably the turfgrass is Kentucky bluegrass or bermudagrass.

Generally, the amount of imidacloprid used is from 0.1 to 0.4 kg/ha. In a preferred embodiment, from 0.1 to 0.2 kg/ha imidacloprid is used.

The combinations of imidacloprid and the fungicide may be prepared by methods known to those of ordinary skill in the art. Generally, such combinations are applied with agriculturally or horticulturally acceptable adjuvants and additives. Imidacloprid itself is formulated by methods known to those of ordinary skill in the art.

The combinations of the invention may be employed in formulations such as solutions, emulsions, suspensions, powders, foams, pastes, granules, aerosols, very fine capsules in polymeric substances, and in coating compositions for seed, as well as ultra-low-volume (ULV) formulations.

The formulations of the invention are used in the customary manner, for example, by watering, spraying, atomizing, scattering, brushing on and as a powder for dry seed treatment, a solution for seed treatment, a water-soluble powder for seed treatment, a water-soluble powder for slurry treatment, or by encrusting.

These formulations are produced in a known manner, for example, by mixing the active compounds with extenders, that is, liquid solvents, liquefied gases under pressure, and/or solid carriers, optionally with the use of surface-active agents, that is emulsifying agents and/or dispersing agents, and/or foam-forming agents. When using water as an extender, organic solvents can, for example, also be used as auxiliary solvents. Suitable liquid solvents include aromatics, such as xylene, toluene, or alkylnaphthalenes, chlorinated aromatics or chlorinated aliphatic hydrocarbons, such as chlorobenzenes, chloroethylenes, or methylene chloride, aliphatic hydro-carbons, such as cyclohexane or paraffins, for example, mineral oil fractions, alcohols, such as butanol or glycol as well as their ethers and esters, ketones, such as acetone, methyl ethyl ketone, methyl isobutyl ketone, or cyclohexanone, strongly polar solvents, such as dimethylformamide and dimethyl sulfoxide, as well as water. Suitable liquefied gaseous extenders or carriers include liquids that are gaseous at ambient temperature and under atmospheric pressure, for example, aerosol propellants, such as halogenated hydrocarbons, as well as butane, propane, nitrogen, and carbon dioxide. Suitable solid carriers include ground natural minerals, such as kaolins, clays, talc, chalk, quartz, attapulgite, montmorillonite, or diatomaceous earth, and ground synthetic minerals, such as highly disperse silica, alumina and silicates. Suitable solid carriers for granules include crushed and fractionated natural rocks such as calcite, marble, pumice, sepiolite, and dolomite, as well as synthetic granules of inorganic and organic meals, and granules of organic material such as sawdust, coconut shells, maize cobs, and tobacco stalks. Suitable emulsifying and/or foam-forming agents include non-ionic and anionic emulsifiers, such as polyoxy-ethylene fatty acid esters, polyoxyethylene fatty alcohol ethers, for example alkylaryl polyglycol ethers, alkylsulfonates, alkyl sulfates, arylsulfonates, as well as albumen hydrolysis products. Suitable dispersing agents include lignin-sulfite waste liquors and methylcellulose.

Adhesives such as carboxymethylcellulose and natural and synthetic polymers in the form of powders, granules or latices, such as gum arabic, polyvinyl alcohol, and polyvinyl acetate, as well as natural phospholipids, such as cephalins and lecithins, and synthetic phospholipids, can be used in the formulations. Other additives can be mineral and vegetable oils.

It is possible to use inert colorants such as inorganic pigments, such as iron oxide, titanium oxide, and Prussian Blue, and organic dyestuffs, such as alizarin dyestuffs and azo dyestuffs, and trace nutrients, such as salts of iron, manganese, boron, copper, cobalt, molybdenum, and zinc.

The formulations in general contain between 0.1 and 95 per cent by weight of active compound, preferably between 0.5 and 90%. Imidacloprid is preferably applied in formulations of from 0.05% to 5%. Generally, polymeric dithiocarbamate fungicides are applied as 50% to 90% by weight formulations. Strobiluens are generally applied as 0.1 to 50% formulations. Clorothalonil is generally applied as 20% to 90% formulations.

The formulations of the inventions are used in the customary manner, for example, by watering, spraying, atomizing, impregnating, foaming scattering, and brushing on.

The unexpected fungicidal activity of the combinations according to the invention can be seen from the examples that follow. While the individual active compounds or the known active compound combinations show weaknesses with regard to the fungicidal activity, the data presented in the tables of the examples that follow show clearly that the activity found for the active compound combinations according to the invention exceeds the total of the activities of individual active compounds and also exceeds the activities of the known active compound combinations.

The following examples illustrate the invention and are not intended to be limiting in any aspect of the invention.

### EXAMPLES

### Example 1

Bentgrass var. ‘Crenshaw’ was seeded in 10 in.×12 in. (25 cm×30 cm) peat flats containing steam sterilized 80/20 greens mix. Flats were watered daily with an overhead misting system. Plots were fertilized with 200 ml of a 288 ppm 20-20-20 Regal Green® fertilizer solution 23 days later. Imidacloprid (481 g/Ha) was applied according to the Merit® insecticide label the same day that fertilizer was applied. Fungicide treatments were applied 7 days later with a CO₂ backpack sprayer at 2.0 gal./1000 ft² (i.e., 81.5 liters/1000 m²) with a single 8003E nozzle. Two doses of each fungicide were tested. Plots were inoculated with Sclerotinia homoeocarpa (Dollar Spot) 2 days after the fungicides were applied by placing two 1-in. (2.5-cm) pieces of infested fescue leaves on each flat. Results are presented in Table 1 (where B+a number represents days after application of the herbicide component).

TABLE 1
Percent infection by S. homoeocarpa of turf flats treated with
imidacloprid + fungicide combinations (doses are g/Ha)

| | % Dollar Spot | | | | | | |
|---|---|---|---|---|---|---|---|
| | Rate | | | | | | |
| Treatment | g/Ha | B + 7 | B + 10 | B + 13 | B + 17 | B + 21 | B + 24 |
| UTC + imidacloprid | 481 | 16.7 | 28.3 | 35.0 | 38.3 | 41.7 | 48.3 |
| UTC | | 14.3 | 23.3 | 30. | 36.7 | 40.0 | 46.7 |
| thiophanate-Me + imidacloprid | 763 + 481 | 4.7 | 6.7 | 5.7 | 11.0 | 20.7 | 23.3 |
| thiophanate-Me | 763 | 3.7 | 5.7 | 3.3 | 3.7 | 7.7 | 11.7 |
| thiophanate-Me + imidacloprid | 1526 + 481 | 1.0 | 2.0 | 0.7 | 1.7 | 4.3 | 8.3 |
| thiophanate-Me | 1526 | 0.7 | 0.7 | 0.7 | 0.7 | 0.3 | 1.7 |
| mancozeb + imidacloprid | 4882 + 481 | 8.3 | 21.7 | 28.3 | 38.3 | 48.3 | 55.0 |
| mancozeb | 4882 | 8.7 | 18.3 | 30.0 | 41.7 | 50.0 | 55.0 |
| mancozeb + imidacloprid | 9763 + 481 | 6.0 | 11.7 | 16.7 | 25.0 | 35.0 | 40.0 |
| mancozeb | 9763 | 6.0 | 16.7 | 25.0 | 36.7 | 43.3 | 50.0 |
| triadimefon + imidacloprid | 191 + 481 | 7.7 | 13.3 | 15.0 | 23.3 | 30.0 | 35.0 |
| triadimefon | 191 | 6.7 | 16.7 | 16.7 | 25.0 | 31.7 | 40.0 |
| triadimefon + imidacloprid | 382 + 481 | 4.0 | 9.3 | 10.0 | 16.7 | 20.7 | 27.3 |
| triadimefon | 382 | 7.7 | 11.7 | 12.7 | 16.7 | 20.0 | 23.3 |
| iprodione + imidacloprid | 573 + 481 | 11.7 | 26.7 | 35.0 | 46.7 | 53.3 | 53.3 |
| iprodione | 573 | 13.3 | 26.7 | 36.7 | 46.7 | 48.3 | 53.3 |
| iprodione + imidacloprid | 1146 + 481 | 11.7 | 23.3 | 28.3 | 35.0 | 40.0 | 48.3 |
| iprodione | 1146 | 13.3 | 26.7 | 31.7 | 46.7 | 46.7 | 51.7 |
| chlorothalanil + imidacloprid | 3147 + 481 | 4.0 | 6.7 | 6.7 | 11.0 | 15.0 | 21.7 |
| chlorothalanil | 3147 | 5.33 | 11.0 | 15.0 | 20.0 | 25.0 | 31.7 |
| chlorothalanil + imidacloprid | 6293 + 481 | 5.0 | 7.3 | 5.0 | 6.3 | 11.0 | 15.0 |
| chlorothalanil | 6293 | 5.0 | 11.7 | 9.3 | 11.7 | 16.7 | 23.3 |
| trifloxystrobin + imidacloprid | 77 + 481 | 11.7 | 21.7 | 31.7 | 40.0 | 40.0 | 40.0 |
| trifloxystrobin | 77 | 12.7 | 25.0 | 35.0 | 41.7 | 46.7 | 51.7 |
| trifloxystrobin + imidacloprid | 153 + 481 | 7.7 | 15.0 | 20.0 | 25.0 | 28.3 | 33.3 |
| trifloxystrobin | 153 | 7.7 | 14.3 | 23.3 | 36.7 | 43.3 | 50.0 |
| boscalid + imidacloprid | 96 + 481 | 11.7 | 23.3 | 20.0 | 31.7 | 40.0 | 46.7 |
| boscalid | 96 | 8.3 | 13.3 | 16.7 | 30.0 | 33.3 | 41.7 |
| boscalid + imidacloprid | 193 + 481 | 7.7 | 16.7 | 16.7 | 23.3 | 31.7 | 36.7 |
| boscalid | 193 | 7.7 | 12.7 | 13.3 | 20.0 | 26.7 | 30.0 |

UTC = untreated control

Results show that imidacloprid had little no effect on the efficacy of iprodione, triadimefon, boscalid, or thiophanate-Me. Turf flats treated with combinations containing imidacloprid plus the fungicides trifloxystrobin, chlorothalanil, and mancozeb showed less infection than did flats treated with the fungicides by themselves. The improvement in efficacy was observed at both the low and high fungicide doses tested for chlorothalanil and trifloxystrobin and at the higher dose of mancozeb. For imidacloprid plus chlorothalanil and trifloxystrobin combinations, the imidacloprid plus the low dose of the fungicide was equal to or greater in efficacy than was the corresponding fungicide at the high dose. Imidacloprid alone had no affect on incidence of disease.

### Example 2

Bentgrass var. ‘Crenshaw’ was seeded in 10 in.×12 in. (ca. 25 cm×30 cm) peat flats containing steam sterilized 80/20 greens mix. Flats were watered daily with an overhead misting system. Plots were fertilized on 26 days later with 200 ml of a 288 ppm 20-20-20 Regal Green fertilizer solution. Treatments were applied with a CO₂ backpack sprayer at 2.0 gal./1000 ft² (i.e., 81.5 liters/1000 m²), with a single 8003E nozzle. Imidacloprid (481 g/Ha) was applied the same day and mancozeb fungicide was applied one week later. Two doses of each fungicide were tested. Plots were inoculated with Pythium aphandermatum 2 days after the fungicides were applied by placing two 1-in (2.5-cm) pieces of infested fescue leaves on each flat. Results are presented in Table 2 (where B+a number represents days after application of the herbicide component).

TABLE 2
Percent infection by P. aphanidermatum of turf flats treated with
imidacloprid + fungicide combinations (doses are g Al/Ha)

| | % Pythium | | | |
|---|---|---|---|---|
| | Rate | | | B + |
| Treatment | g/Ha | B + 6 | B + 8 | 14 |
| UTC + imidacloprid | 481 | 11.7 | 20.0 | 36.7 |
| UTC | | 10.0 | 13.3 | 26.7 |
| fosetyl + pigment + imidacloprid | 5093 + 481 | 2.3 | 3.7 | 3.7 |
| fosetyl + pigment | 763 | 1.7 | 2.0 | 3.7 |
| fosetyl + pigment + imidacloprid | 10180 + 481 | 0.7 | 2.0 | 2.0 |
| fosetyl + pigment | 10180 | 1.3 | 1.3 | 2.3 |
| metalaxyl + imidacloprid | 382 + 481 | 0 | 0.3 | 0.7 |
| metalaxyl | 382 | 0.7 | 0.7 | 1.3 |
| metalaxyl + imidacloprid | 764 + 481 | 0 | 0 | 0 |
| metalaxyl | 764 | 0 | 0 | 1.3 |
| azoxystrobin + imidacloprid | 305 + 481 | 5.7 | 8.3 | 11.0 |
| azoxystrobin | 305 | 4.7 | 4.7 | 5.7 |
| azoxystrobin + imidacloprid | 611 + 481 | 1.7 | 2.3 | 4.3 |
| azoxystrobin | 611 | 2.7 | 3.3 | 3.3 |
| propamocarb + imidacloprid | 1146 + 481 | 6.7 | 10.3 | 13.3 |
| propamocarb | 1146 | 6.7 | 9.3 | 12.7 |
| propamocarb + imidacloprid | 2292 + 481 | 4.0 | 6.0 | 7.7 |
| propamocarb | 2292 | 3.0 | 5.0 | 7.0 |
| mancozeb + imidacloprid | 9765 + 481 | 5.7 | 11.0 | 21.7 |
| mancozeb | 9765 | 10.0 | 15.0 | 36.7 |
| mancozeb + imidacloprid | 19530 + 481 | 7.7 | 11.7 | 21.7 |
| mancozeb | 19530 | 7.7 | 11.7 | 20.0 |

UTC = untreated control

Results show that imidacloprid had little or no effect on the efficacy of fungicides tested except for mancozeb. The combination containing the low dose of mancozeb and the imidacloprid provided better control of Pythium than did the mancozeb alone at all three assessment dates.

### Example 3

Six-inch (15-cm) diameter pots were filled to the rim with ProMix® BX potting soil and leveled off. Grass seed (0.5 g) was distributed evenly over the whole mix surface. The seed was watered in very gently. The grass was fertilized once 17 days later with Peters 20-10-20 at 100 ppm. The first cut was done on 11 days later; the grass was allowed to re-grow and cut 26 days later. Cutting was done at 2 in. (5 cm) height, using a round plastic cylinder that fit over the pot. The cut was made with hedge sheers and finished with scissors. Treatments were applied one day later using a volume of 20 ml per pot, followed with 117 ml of water/pot. The grass clippings were harvested and dried for dry weight determination 2 weeks after treatment (“WAT”) and 4 WAT. The grass was rated visually for vigor 8 WAT, using a 1 to 5 scale, before harvesting at the soil line. Dry weight and vigor data were subjected to analysis of variance (Fisher's Protected LSD, P=0.05).

The grass had germinated well within 30 days. Powdery mildew was noticed on some plants at 43 days after seeding, and became widespread in the plot. The powdery mildew coating appeared to grow more densely on the untreated plants. There was more browning in the grass with the more severe powdery mildew infestation, hence the visual vigor ratings indicate a benefit from the imidacloprid treatments. Dry weights were significantly improved in two of the imidacloprid treatments at the 2 WAT harvest, and in all three of the treatments at 8 WAT harvest. Imidacloprid treatment appeared to provide some slight but measurable benefits that did not relate to insect control. The invasion of the powdery mildew prevented the assessment of imidacloprid in the absence of pest pressure but it was serendipitously discovered that imidacloprid could have an effect on disease resistance in turf.

### Example 4

A greenhouse trial was conducted on Kentucky bluegrass with 10 replications and arranged in a simple block design. Six-inch (15-cm) diameter pots with a mix of 50% standard soil and 50% Promix® were seeded with 0.5 g of Kentucky bluegrass seeds. Pots were fertilized weekly and allowed to grow for 6 weeks then cut back to 2 in. (5 cm) height before applications were made. Drench applications of imidacloprid 75 WP at 0.25, 0.4, and 1.0 lbs/A (i.e., 0.28, 0.45, and 1.12 kg/Ha, respectively) were mixed with 20 ml of water then drenched on pots. After applications, pots were irrigated with 0.25 in, (ca. 0.63 cm of water. Evaluations were made at 2 and 6 weeks on disease severity by using a 1 to 9 rating scale, where 1=best (no disease) and 9=dead (heavily diseased). Dry weights were taken with the grass mass cuttings at 2 in. (5 cm) heights at 2 and 6 weeks after applications. Plants were sacrificed at 6 weeks, grass was cut to the soil line, roots were washed, and dry weights on roots were taken.

The imidacloprid drench at different rates had similar mass clipping yields and disease severity as the untreated at the 2 WAT. At 6 WAT, the yield from the mass clippings again did not vary from the untreated pots. The bluegrass pots did have powdery mildew and the treatments of imidacloprid did have an impact on the disease severity on the bluegrass (3.1 rating) over the untreated (4.2) at the 6 WAT evaluation. The results of this greenhouse trial suggests that the imidacloprid drenches did have an impact on the disease severity of powdery mildew on Kentucky bluegrass, as the imidacloprid treated pots were not as infested with powdery mildew as the untreated pots. No noticeable differences in disease severity was observed between the imidacloprid treatments. Influence by the imidacloprid treatments tended to take at least 6 WAT before differences in disease severity were noticeable.

TABLE 3

| | Effect of Imidacloprid on Kentucky Bluegrass | | | |
|---|---|---|---|---|
| | 2 Weeks after treatment | | 6 Weeks after treatment | |
| Treatments | Powdery | | Powdery | |
| (Rate lbs/A) | mildew | Leaf | mildew | Leaf |
| (Rate kg/Ha) | rating* | weight (g) | rating* | weight (g) |
| Untreated | 3.4 | 1.1 | 4.2 | 0.3 |
| Imidacloprid | 3.4 | 1.2 | 3.2 | 0.3 |
| (0.25) (0.28) | | | | |
| Imidacloprid | 3.4 | 1.3 | 3.1 | 0.3 |
| (0.4) (0.45) | | | | |
| Imidacloprid | 3.4 | 1.2 | 3.1 | 0.3 |
| (1.0) (1.12) | | | | |

*Powdery mildew rating: 1 = best (no disease) to 9 = dead (heavily diseased)

### Example 5

Four sets of twenty-four 10 in.×12 in. (25 cm×30 cm) flats were filled with sterilized sand and each set was seeded with either Kentucky bluegrass, Crenshaw L-93 bentgrass, bermudagrass, or K-31 tall fescue. Each flat was fertilized weekly with 20-20-20 soluble fertilizer at 0.144 g per 200 ml of water (equivalent to 4 lbs/year/acre). The trial was replicated once.

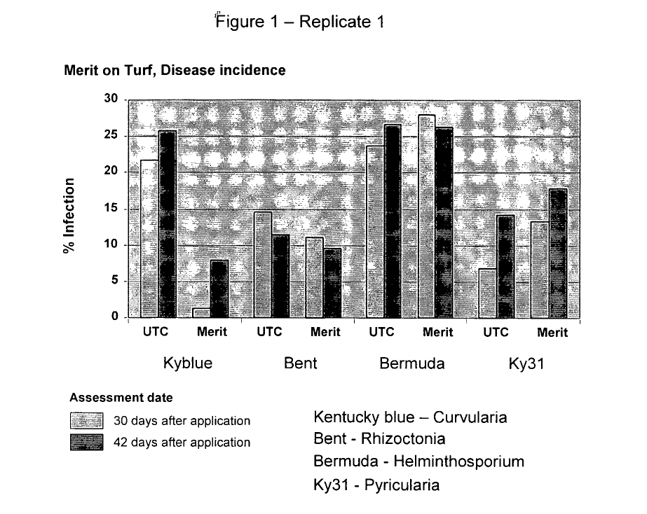

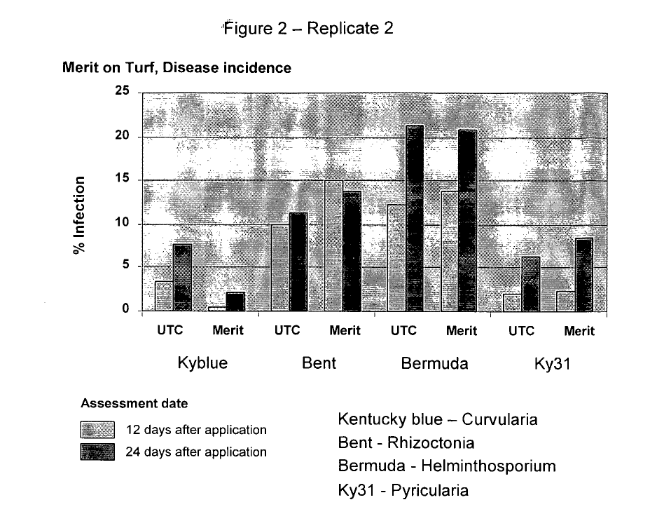

Twelve flats in each set were treated with Merit 75 WP equivalent to 8.6 oz/acre per 80 gal. (ca. 2.0 g/Ha per 100 liter) of water (spray application) for each turf variety and twelve flats remained untreated. Replicate 1 was treated 25 days after seeding and Replicate 2 was treated 28 days after seeding. Disease outbreaks began approximately the time of treatment. Assessments of the infection percentage were done at 13 and 25 days after treatment. The data are shown in FIGS. 1 and 2. In both replicates, imidacloprid (Merit) provided good control of Curvularia on the Kentucky bluegrass. The percent disease infection at the first and second assessments in the first trial was 22 and 26%, respectively, while the percent infection in the imidacloprid treated flats was 1 and 8% at the first and second assessment dates, respectively. In the second trial, disease pressure was lower, but the untreated flats had 3 and 8% infection at the first and second assessment dates, whereas the imidacloprid treated flats had 0.5 and 2% at the two assessment dates. Imidacloprid did not provide control of the other diseases that broke out on the other turf varieties in either trial.

### Example 6

Bentgrass var. ‘Crenshaw’ was seeded in 10 in.×12 in. (25 cm×30 cm) peat flats containing steam sterilized 80/20 greens mix. Flats were watered daily with an overhead misting system. Plots were fertilized on 11/20 with 200 ml of a 288 ppm 20-20-20 Regal Green fertilizer solution. Treatments were applied with a CO₂ backpack sprayer at 2.0 gal./1000 ft² (i.e., 81.5 liters/1000 m²) and a single 8003E nozzle. Imidacloprid was applied on 16 days after seeding and fungicides applied 21 days after seeding and 35 days after seeding. Plots were inoculated 18 days after seeding with 0.25 g of fescue seed infected with Rhizoctonia solani. Results are presented in Table 4 (where B+a number represents days after application of the herbicide component).

TABLE 4

| | % Brown Patch infection | | | |
|---|---|---|---|---|
| | Rate | | | |
| Treatment | g/Ha | B + 6 | B + 8 | B + 10 |
| UTC + imidacloprid | 481 | 53.3 | 73.3 | 80.0 |
| UTC | | 41.7 | 73.3 | 81.7 |
| mancozeb + imidacloprid | 4882 + 481 | 28.3 | 43.3 | 33.3 |
| mancozeb | 4882 | 28.3 | 38.3 | 63.3 |
| mancozeb + imidacloprid | 9763 + 481 | 15.0 | 21.7 | 36.7 |
| mancozeb | 9763 | 21.7 | 31.7 | 56.7 |
| tridimefon + imidacloprid | 191 + 481 | 36.7 | 60.0 | 75.0 |
| triadimefon | 191 | 33.3 | 50.0 | 73.3 |
| tridimefon + imidacloprid | 382 + 481 | 23.3 | 36.7 | 71.7 |
| triadimefon | 382 | 21.7 | 36.7 | 65.0 |
| chlorothalanil + imidacloprid | 3147 + 481 | 12.7 | 23.3 | 38.3 |
| chlorothalanil | 3147 | 18.3 | 30.0 | 46.7 |
| chlorothalanil + imidacloprid | 6293 + 481 | 16.7 | 20.0 | 26.7 |
| chlorothalanil | 6293 | 16.0 | 18.3 | 25.0 |
| trifloxystrobin + imidacloprid | 77 + 481 | 5.0 | 11.0 | 26.7 |
| trifloxystrobin | 77 | 7.3 | 11.7 | 25.0 |
| trifloxystrobin + imidacloprid | 153 + 481 | 4.3 | 8.7 | 20.0 |
| trifloxystrobin | 153 | 4.3 | 5.3 | 12.7 |
| flutolanil + imidacloprid | 80 + 481 | 25.0 | 43.3 | 70.0 |
| flutoanil | 80 | 21.7 | 50.0 | 78.3 |
| flutolanil + imidacloprid | 160 + 481 | 21.7 | 40.0 | 66.7 |
| flutoanil | 160 | 23.3 | 40.0 | 66.7 |

UTC = untreated control

Disease pressure and conditions for disease development were extremely high. Treatments consisting of imidacloprid in combination with the fungicides triadimefon, trifloxystrobin, chlorothalanil, and flutolanil did not provide control that differed from treatments of these fungicides alone. However, the combination of imidacloprid and mancozeb was more efficacious than mancozeb alone at both doses of mancozeb tested. Imidacloprid alone had no effect on the disease.

### Example 7

Bentgrass sod var. ‘Crenshaw’ was cut and placed in 6″×7″ (15 cm×17.5 cm) peat flats containing steam-sterilized 80/20 greens mix during the spring. To create conditions favorable for the development of Pythium, the flats were watered daily with an overhead misting system to provide conditions favorable to the development on disease. In addition, plots were fertilized weekly with 100 ml of a 244 ppm 20-20-20 Regal Green fertilizer solution. Imidacloprid at 481 g/Ha was applied four days after being placed in the flats. Fungicides were applied ten days after application of imidacloprid with a CO₂ backpack sprayer at 2.0 gal. /1000 ft² (i.e., 81.5 liters/1000 m²) using a single 8003E nozzle. Plots were inoculated with 2 one-inch (5-cm) sections of Pythium aphanedermatum-infested fescue leaves three days after application of the fungicides, and the percent infection in the plots was measured for the next 20 days. Results are presented in Table 5 (where A+a number represents days after application of imidacloprid).

TABLE 5
Effect of imidacloprid on development of Pythium in untreated and
fungicide-treated turf plots

| | Rate | % Pythium | | | | | |
|---|---|---|---|---|---|---|---|
| Treatment | g/Ha | A + 8 | A + 11 | A + 15 | A + 18 | A + 22 | A + 28 |
| UTC + imidacloprid | 481 | 17.5 | 32.5 | 40.0 | 38.8 | 25.0 | 12.0 |
| UTC | | 10.8 | 47.5 | 63.8 | 67.5 | 63.8 | 43.8 |
| fosetyl + pigment + imidacloprid | 5093 + 481 | 8.0 | 8.3 | 14.5 | 12.5 | 7.8 | 4.0 |
| fosetyl + pigment | 763 | 4.5 | 6.0 | 12.5 | 8.8 | 6.3 | 2.5 |
| fosetyl + pigment + imidacloprid | 10180 + 481 | 1.3 | 1.5 | 5.0 | 7.0 | 5.8 | 5.0 |
| fosetyl + pigment | 10180 | 8.5 | 3.8 | 5.0 | 3.8 | 1.3 | 0.8 |
| metalaxyl + imidacloprid | 382 + 481 | 4.0 | 10.0 | 11.3 | 8.8 | 5.0 | 2.5 |
| metalaxyl | 382 | 6.8 | 16.3 | 25.0 | 28.7 | 28.0 | 16.3 |
| metalaxyl + imidacloprid | 764 + 481 | 3.0 | 0 | 3.3 | 3.3 | 2.5 | 0.5 |
| metalaxyl | 764 | 1.3 | 0 | 0.3 | 1.5 | 0.8 | 0 |
| azoxystrobin + imidacloprid | 305 + 481 | 11.0 | 18.0 | 23.8 | 20.8 | 11.3 | 4.5 |
| azoxystrobin | 305 | 3.3 | 17.5 | 44.5 | 43.8 | 40.0 | 26.3 |
| azoxystrobin + imidacloprid | 611 + 481 | 7.5 | 22.5 | 38.8 | 31.3 | 23.8 | 12.0 |
| azoxystrobin | 611 | 8.8 | 17.5 | 30.0 | 31.3 | 29.5 | 18.0 |
| propamacarb + imidacloprid | 1146 + 481 | 3.3 | 11.5 | 15.8 | 13.3 | 7.8 | 4.5 |
| propamacarb | 1146 | 8.3 | 13.3 | 27.5 | 36.3 | 38.7 | 22.5 |
| propamacarb + imidacloprid | 2292 + 481 | 7.0 | 21.3 | 36.3 | 42.5 | 40.0 | 21.3 |
| propamacarb | 2292 | 3.3 | 7.0 | 12.5 | 13.8 | 14.0 | 13.8 |
| mancozeb + imidacloprid | 9765 + 481 | 11.3 | 33.8 | 50.0 | 50.0 | 43.8 | 26.3 |
| mancozeb | 9765 | 12.0 | 27.5 | 50.0 | 47.5 | 40.0 | 17.5 |
| maconzeb + imidacloprid | 19530 + 481 | 8.8 | 25.0 | 40.0 | 38.8 | 32.5 | 18.3 |
| mancozeb | 19530 | 5.3 | 24.5 | 40.0 | 46.3 | 45.0 | 33.8 |

UTC = untreated control

Disease pressure was high; by 18 days after treatment the percent infection in the untreated plots was 67.5%. Plots treated with imidacloprid alone had much less Pythium than did the untreated plots from 11 days after treatment on. The presence of imidacloprid also improved the level of control provided by several of the fungicides. No effect on the efficacy of propamacarb, fosetyl plus pigment, and mancozeb was observed. However, control of Pythium with the low rates of metalaxyl and azoxystrobin was increased by over 50% relative to the fungicide treatments alone.

### Example 8

Established bermudagrass (cv. ‘TifEagle’) on a golf course in Florida was treated in late spring with imidacloprid at 0.4 lb/A (i.e., 0.45 kg/Ha). For comparison, two different fungicide spray programs were applied to nearby plots. The two fungicide spray programs were (1) fosetyl+iprodione at (4 oz.+4 oz.) per 1000 ft² [(1.2 g+1.2 g) per m²] alternated with fosetyl+trifloxystrobin at (4 oz.+0.15 oz.) per 1000 ft² [(1.2 g+46 mg) per m²], and (2) fosetyl+iprodione at (4 oz.+4 oz.) per 1000 ft² [(1.2 g+1.2 g) per m²] alternated with flutolanil at 2.2 oz product/1000 ft² (0.67 g) per m²). The fungicide applications were made every two weeks. In comparison, the imidacloprid-treated plots received only a single application of active ingredient.

At the time of treatment, Curvularia disease was just beginning to develop (i.e., the mean percent infection in all plots was 3% of the turf cover). The spread of the disease was monitored weekly for twelve weeks, and turf quality, measured on a 0 to 9 scale (0=dead turf and 9=perfect quality). At 13 weeks after treatment the disease pressure in the untreated plots dropped significantly due to weather; at this point the experiment was terminated. Effects of the various treatments on disease incidence are described in Table 6 (where A+a number represents days after application of imidacloprid). Data are expressed as % turf infected with disease.

TABLE 6
Effect of imidacloprid and fungicide spray programs on the
development on Curvularia on bermudagrass late spring through
summer in Florida

| Assessment | Imidacloprid | | | |
|---|---|---|---|---|
| date (after | (0.4 lb/A) | Untreated | Fungicide | Fungicide |
| application) | (0.45 kg/Ha) | Control | program 1 | program 2 |
| A + 1 | 1 | 3 | 3 | 5 |
| A + 8 | 1 | 3 | 0 | 1 |
| A + 15 | 1 | 4 | 0 | 0 |
| A + 22 | 0 | 1 | 0 | 0 |
| A + 29 | 0 | 3 | 0 | 1 |
| A + 37 | 0 | 4 | 0 | 0 |
| A + 43 | 0 | 0 | 0 | 0 |
| A + 51 | 16 | 26 | 5 | 8 |
| A + 58 | 21 | 24 | 3 | 8 |
| A + 66 | 54 | 64 | 50 | 26 |
| A + 72 | 30 | 60 | 25 | 23 |
| A + 79 | 34 | 74 | 29 | 24 |
| A + 86 | 38 | 69 | 26 | 25 |
| A + 94 | 16 | 36 | 18 | 14 |

The data in Table 6 show that disease incidence remained low in all plots until 8 WAT, after which the percent infection in the untreated control rose sharply. In comparison, the incidence of disease in the imidacloprid-treated plot increased at a much slower rate than did the untreated control; the development of the disease was comparable to that observed in the plots treated with fosetyl plus iprodione followed by fosetyl plus trifloxystrobin, at two week intervals. The percent disease control in the plots treated with fosetyl plus iprodione followed by flutolanil at two week intervals was superior to the other treatments for at least about 8 weeks after treatment, but by the end of the trial all treated plots showed a comparable level of disease.

What is claimed is:

1. A method of controlling or suppressing a phytopathogenic infection of grass or turfgrass by a phytopathogenic fungal organism of the order Heliotales comprising applying a synergistically effective amount of a combination of (i) imidacloprid and (ii) optionally, a fungicide that is a polymeric dithiocarbamate fungicide, a strobilurin fungicide, a phenyl-anilide fungicide, or chlorothalonil.

2. The method according to claim 1 wherein the combination is applied separately or sequentially.

3. The method according to claim 1 wherein the organism is of the genus Sclerotinia spp.

4. The method according to claim 3 wherein the organism is the species Sclerotinia homoeocarpa.

5. The method according to claim 1 wherein the fungicide is a polymeric dithiocarbamate fungicide.

6. The method according to claim 5 wherein the polymeric dithiocarbamate fungicide is mancopper, mancozeb, maneb, metiram, polycarbamate, propineb or zineb.

7. The method according to claim 6 wherein the polymeric dithiocarbamate fungicide is mancozeb.

8. The method according to claim 1 wherein the fungicide is a strobilurin fungicide.

9. The method according to claim 8 wherein the strobilurin fungicide is azoxystrobin, dimoxystrobin, fluoxastrobin, kresoxim-methyl, metominostrobin, orysastrobin, picoxystrobin, pyraclostrobin, or trifloxystrobin.

10. The method according to claim 8 wherein the strobilurin fungicide is trifloxystrobin.

11. The method according to claim 1 wherein the fungicide is a phenylanilide fungicide.

12. The method according to claim 8 wherein the phenylanilide fungicide is benalaxyl, benalaxyl-M, boscalid, furalaxyl, metalaxyl, or metalaxyl-M.

13. The method according to claim 8 wherein the phenylanilide fungicide is metalaxyl.

14. The method according to claim 1 wherein the fungicide is chlorothalonil.

15. A method of controlling or suppressing a phytopathogenic infection of grass or turfgrass by a phytopathogenic organism of the family Rhizoctonia or Pythium comprising applying a synergistically effective amount of a combination of (i) imidacloprid and (ii) a polymeric dithiocarbamate fungicide.

16. The method according to claim 15 wherein the combination is applied separately or sequentially.

17. The method according to claim 15 wherein the polymeric dithiocarbamate fungicide is mancopper, mancozeb, maneb, metiram, polycarbamate, propineb, or zineb.

18. The method of claim 15 wherein the organism is Rhizoctinia solani.

19. The method of claim 15 wherein the organism is Pythium aphanidermatum.

20. A method of controlling a powdery mildew infection in turfgrass which method comprises applying an effective amount of a composition consisting essentially of imidacloprid to a turfgrass that is infected or expected to be infected with powdery mildew.

21. A method of controlling Curvularia spp infections in a Poa spp. turfgrass comprising applying a composition consisting essentially of imidacloprid to the turfgrass.

22. The method of claim 21 wherein the turfgrass is Kentucky bluegrass or bermudagrass.
